(19) United States
(12) Patent Application Publication
(10) Pub. No.: US 2005/0284123 A1
(43) Pub. Date: Dec. 29, 2005

(54) Fabric for harvesting fruit

(76) Inventors: Alan E. Learned, Powhatan, VA (US); Anthony J. Palermo, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/154,486

(22) Filed: Jun. 16, 2005

Related U.S. Application Data
(60) Provisional application No. 60/581,199, filed on Jun. 18, 2004.

(51) Int. Cl. A01D 46/00

(52) U.S. Cl. 56/330

(57) ABSTRACT

A reusable sheet for the drying of fruit thereon comprising a nonwoven fabric having a coefficient of friction of less than about 0.15, a tensile strength of greater than about 89 N in both the machine direction and the cross direction and an L* color value of between about 40 and about 90.

### BACKGROUND OF THE INVENTION

1. Field of the Invention

This invention is directed to a fabric for use in drying harvested fruits, particularly grapes.

2. Description of the Related Art

Current grape harvesting uses chemically treated paper trays, either as separate sheets in the handpicking process or continuous sheets in the mechanical harvesting process, as the substrate on which to dry the grapes into raisins. The material must withstand the abrasion and tear forces that occur during the mechanical harvesting and drying processes. In the mechanical harvesting process, the green grapes are laid down on continuous sheets for drying. It takes about 7-10 days (14-21 days for handpicking) for the grapes to dry into raisins. The dried grapes (raisins) are then picked up from the sheets. The papers are typically given a chemical treatment to improve their durability, but even with this treatment, they become very brittle and difficult to remove from the fields after exposure to the outdoor environment for 3-4 weeks. Additionally, the chemical treatment of the paper causes difficulty in the recycling process as the chemicals are released to the waste streams.

Disposal of the paper after only one use currently consists of burning the paper in the fields. California is the primary producer of raisin/grapes in the U.S., with the San Joaquin Valley being the largest producer of raisins in the world. However, California has legislation in progress that would forbid the practice of burning the paper. This would require significantly increased costs for growers.

Agricultural films have been tried in the mechanical harvesting process, but low stiffness and difficulty in handling the film have been encountered.

As such, there is a need for a durable fabric that can be employed in the mechanical harvesting of grapes that are dried into raisins that can avoid the necessity for disposal by burning.

### DETAILED DESCRIPTION OF THE INVENTION

The invention is a colored fabric that can be used for applications that require a smooth surface, good mechanical durability, UV stability, and where a non-white substrate is preferred, such as the mechanical harvesting of grapes and the drying of the grapes into raisins. The fabric can be prepared for use in multiple harvesting seasons by removing the raisins, rewinding from the field and then storing until the next season. Specifically, the invention is a durable, smooth-surfaced nonwoven fabric with a coefficient of friction (COF) of less than 0.15, tensile strength greater than 20 lb. (89 newtons(N)) in both the machine direction (MD) and the cross machine direction (CD). Further, the fabric is ultraviolet (UV) stabilized and has an appropriate color (L*<90). More preferably, the colors would fall within the range between L* of ˜40 and 90 would be suitable. L* is the luminescence (i.e., darkness or lightness of the color) component of a color as defined by the CIE (Commission Internationale de L'Eclairage) as one component of the L*a*b* model for defining color. The a* value defines the color on the blue-red scale, and the b* value defines the color on the blue-yellow scale. The L*, a*, and b* color values are measured according to ASTM E308-01. The L* value of the color of the nonwoven fabric or sheet affects the surface temperature of the nonwoven. It is important in the use of the nonwoven sheet of the invention to use a color that is right for the conditions in use. For instance, if the surface temperature of the nonwoven sheet is too low, then the drying time of the fruit will be long and the productivity of the dried fruit producers will suffer. Extending the drying time also increases the risk of exposure to rain, which can compromise the yield. However, if the surface temperature of the nonwoven sheet is too high the over-accelerated drying of the fruit will caramelize the grapes, resulting in yield loss for the producers. Additionally, a fabric can be made with a different L* value on the two sides of the sheet. The higher L* value would dry the raisins faster and a lower L* value would minimize caramelizing of the raisins during particularly hot drying periods. The growers could then choose the more suitable surface based on the weather forecast for the upcoming week.

Although the subject invention is directed primarily to drying grapes for raisins, it is understood that the invention would be likewise applicable for fruits that are used in dried form, such as berries, plums, apricots, and the like.

The fabric can be made of spunbond polyester, polyolefin, or polyamide. Preferably, a spunbond product would be smooth roll calendered. Products having at least two spunbond layers can be used in the invention, the spunbond layer being formed of bicomponent fibers having a center core of polyester, advantageously, polyethylene terephthalate (PET), and an outer sheath layer of polyethylene (PE) or a copolyester. SMS (spunbond-meltblown-spunbond) structures can also be used, including these spunbond layers and a meltblown layer. The meltblown layer can be formed from bicomponent side-by-side polyethylene/polyester fibers.

It has also been found that a fabric that contains fibers having sheath of fluoropolymer, for example, ethylene-tetrafluoroethylene copolymer (available from E. I du Pont de Nemours and Company, Wilmington, Del. under the trade name Tefzel®) or polyvinylidene fluoride (available from Atofina Chemicals, Inc., Philadelphia, Pa. under the trade name Kynar®) and a core of another polymer (PET, e.g.) would be desirable. Without being held to any theory, it is believed that such a sheet would minimize the raisins sticking to the sheet, a problem that has been encountered with polyolefin drying trays. Moreover, the sheath-core structure would be more cost effective than a sheet made of homopolymer comprised of fluorine-based monomers.

Films of sufficient thickness and orientation, or laminated appropriately are also suitable for the application. The film can be made of spunbond polyester, polyolefin, or polyamide.

The inventive sheet material is preferably a fabric comprised of flashspun plexifilamentary polyethylene fibers, such as TYVEK®, available from E.I. du Pont de Nemours and Co. (Wilmington, Del.).

### EXAMPLES

One example of the invention is a flashspun fabric of TYVEK® with a basis weight of 54 g/m². The coefficient of friction was less than 0.15. The MD tensile strength was 110 N with an elongation-at-break of 14% and a CD tensile strength of 131 N with an elongation-at-break of 19%. Delamination strength was 1.42 N. The fabric had a color rating of L*=81.7, a*=6.02, b*=23.0.

### Field Tests

The following compares the temperature differences between the surface temperature of brown Tyvek® (brown) and white Tyvek® (white) opposite that of commonly used, commercially available paper produced by Pulp, Paper, And Film, Inc., 2822 South Maple Avenue, Fresno, Calif. under the trade name SunBurst®. The brown had a basis weight of 68 g/m² and the color was L*=76.56, a*=9.07, and b*=27.42. The field trial was performed over a period of seven days, where the temperatures of the various sheets were recorded and the drying of the grapes to raisins was evaluated.

The standard paper had an average temperature during the test period of 127° F. The brown had an average temperature during the test period of 125° F. with a peak temperature differential from that of the paper of minus 6 degrees. However, the drying time was substantially the same as with the paper. On the other hand, the white had an average temperature during the test period of 120° F. with a peak temperature differential from that of the paper of minus 14 degrees. As such, the white needed as much as 3 more days to achieve the required level of drying.

1. A reusable sheet for the drying of at least one item of fruit thereon comprising a nonwoven fabric having a first and a second surface, the fabric having a coefficient of friction of less than about 0.15 and a tensile strength of greater than about 89 N in the machine direction and in the cross direction and wherein at least one of the first and second surfaces has an L* color value of between about 40 and about 90.

2. The reusable sheet of claim 1 wherein the first surface has an L* color value of about 40 and the second surface has an L* color value of about 88.

3. The reusable sheet of claim 1, wherein the fabric contains an ultraviolet stabilizer.

4. The reusable sheet of claim 1, wherein the fabric comprises a flash spun plexifilamentary film-fibril sheet.

5. The reusable sheet of claim 4, wherein the fabric comprises high-density polyethylene.

6. The reusable sheet of claim 1, wherein the fabric comprises a calendered spunbond sheet comprising a polymer selected from the group consisting of polyester, polyolefin, and polyamide.

7. The reusable sheet of claim 1 wherein the fabric comprises a film comprising a polymer selected from the group consisting of polyester, polyolefin, and polyamide.

8. The reusable sheet of claim 1 wherein the fabric is calendered and comprises spunbond bicomponent sheath/core fibers wherein the core of the fiber is polyethylene terephthalate and the sheath layer is selected from the group consisting of polyethylene and a copolyester.

9. A process for drying at least one item of fruit, comprising the steps of
a) providing a reusable sheet for the drying of fruit thereon, comprising a nonwoven fabric having a first and a second surface, the fabric having a coefficient of friction of less than about 0.15 and a tensile strength of greater than about 89 N in the machine direction and in the cross direction and wherein at least one of the first and second surfaces has an L* color value of between about 40 and about 90,
b) placing at least one item of fruit on the reusable sheet for a time sufficient to form the fruit into its dried state,
c) removing the at least one item of fruit from the reusable sheet, and
d) preparing the reusable sheet for reuse.

10. The process of claim 9, wherein the first surface has an L* color value of about 40 and the second surface has an L* color value of about 88.

11. The process of claim 9, wherein the fabric contains a UV stabilizer.

12. The process of claim 9, wherein the fabric comprises a flash spun plexifilamentary film-fibril sheet.

13. The process of claim 12, wherein the fabric comprises high-density polyethylene.

14. The process of claim 9, wherein the fabric comprises a calendered spunbond sheet comprising a polymer selected from the group consisting of polyester, polyolefin, and polyamide.

15. The process of claim 9, wherein the fabric comprises a film comprising a polymer selected from the group consisting of polyester, polyolefin, and polyamide.

16. The process of claim 9, wherein the fabric is calendered and comprises spunbond bicomponent sheath/core fibers wherein the core of the fiber is polyethylene terephthalate and the sheath layer is selected from the group consisting of polyethylene and a copolyester.
